(19) United States
(12) Patent Application Publication
(10) Pub. No.: US 2005/0013589 A1
(43) Pub. Date: Jan. 20, 2005

(54) Adding recording functionality to a media player

(75) Inventors: Mehul Y. Shah, Bellevue, WA (US); Vladimir Rovinksy, Redmond, WA (US); Dongmei Zhang, Redmond, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, REDMON, WA (US)

(21) Appl. No.: 10/619,863

(22) Filed: Jul. 14, 2003

(51) Int. Cl. H04N 5/76; G11B 15/04; G11B 19/04

(52) U.S. Cl. 386/94; 360/60; 380/201

(57) ABSTRACT

The present disclosure relates to rendering and recording multimedia content at a computer. The multimedia content may be streamed from a source such as an Internet website, received at the computer, and rendered by the computer. The rendering may include recording the multimedia content if the computer is so authorized by adding a recording component to a linked set of components or filters that perform the rendering of the multimedia content. If the computer is not authorized to record the multimedia content, the recording component is disabled or left out; however, the multimedia content may be processed and rendered through the linked set of components without the recording component.

### TECHNICAL FIELD

This disclosure relates to recording multimedia content and specifically to systems and methods to record streaming multimedia content from a source to a computer.

### BACKGROUND

Presentations such as movies, commercials, song albums, music concerts, and news broadcast may be represented by multimedia content. Multimedia content may be separated into audio and video content. It is becoming more commonplace for computers such as personal computers (PC) to render (i.e., play) multimedia content. A PC may access such multimedia content from a local source such as a resident storage device (e.g. the PC's hard disk) and/or resident media device (e.g., DVD or CD drive on the PC). In particular cases, the PC may access multimedia content from other sources such as other computers and/or media devices through a network connection.

Accessing and playing multimedia content may be performed through a “media player” resident in the PC. A media player typically is implemented in software. An example of a media player is Windows® media player (WMP) by the Microsoft® Corporation.

With the use of the Internet, website sources are also able to stream multimedia content to connected PCs. Streamed multimedia content involves transmitting multimedia content from a server (i.e., a website server computer) across a network (i.e. the Internet) in a continuous flow. A PC, and in particular the media player of the PC, may render the multimedia content immediately instead of waiting for an entire file of the multimedia content to be downloaded from the source.

Streaming multimedia content from the Internet includes live broadcasts of news events, audio/video programs such as music concerts, and promotional content such as commercials and movie trailers. Streaming multimedia content may defined as “on-demand” and “broadcast” content. For on-demand content, a PC through a media player controls playback experience; for example, when to start playback, when to pause, when to stop playback, and when to seek to a specific position in the content. For “broadcast” content, a website source, in particular a server from which multimedia content originates controls the playback experience; for example, when streaming starts and when streaming ends.

PC users may have a limited duration of time to access streaming multimedia content from a website. A live broadcast from a website may only be available for viewing over a defined time. A movie trailer may be removed from a website after the movie is no longer being shown in theatres. Commercials may become outdated and removed from a website.

In certain cases, a PC user may desire to record streaming multimedia content for later viewing such as when a user is not available to view a live news broadcast, or desires to record a movie trailer for later reference. In many instances a website providing streaming multimedia content desires that PCs have the ability to record streaming multimedia content. For example, a website operator has goals for promotional material to be viewed often and by a large number of people. Allowing PCs to record the promotional material helps to achieve the website operator's goals.

Although a great deal of multimedia content may be recorded, a significant amount of multimedia content may be copyrighted and should be protected from being recorded. Although a source (i.e., website) may allow a PC user to experience (i.e., render) the multimedia content, the source may desire to protect multimedia content that is copyrighted from being recorded. For example, an Internet “radio station” website broadcasts a new song promoting an artist; however, the artist does not want a PC to be able record the song, but to have people purchase the song by buying an album or paying for rights to record the song.

In certain cases, a media player may be embedded in a webpage of a website. An example is that of an Internet “radio station” website. The embedded media player provides a user interface (UI) to a “visitor” of the website; however the UI typically provides limited functionality to the visitor and does not allow the visitor to record multimedia content.

Some media players, whether included in a PC or embedded in a webpage, in order to prevent copyrighted content from being copied, forego providing PCs an ability to record multimedia content, whether the multimedia content is copyrighted or not. Therefore a PC user desiring to record non-copyrighted multimedia content for later viewing is not able to perform recording through the media player. This compromises the viewing experience of PC users to view multimedia content when they so desire.

### SUMMARY

The system and methods described herein include selectively providing a recording component in a media player to allow for recording of protected and non-protected multimedia content, where the recording component may be added to a linked set of components that are used to render the multimedia content.

In certain embodiments, the recording component is added to the linked set of components when it is registered and identified to be able to record multimedia content received form particular sources.

### BRIEF DESCRIPTION OF THE DRAWINGS

FIG. 1 is a block diagram illustrating a system of multiple websites providing multimedia content to a personal computer that is configured to play record the multimedia content using a media player.

FIG. 2 is a block diagram illustrating a media player of a personal computer that is configured to receive, render and record multimedia content.

FIG. 3 is a block diagram illustrating a stream recorder and programming interfaces for playing and recording multimedia content on a personal computer.

FIG. 4 is a flowchart illustrating operation of an exemplary recording session of a personal computer receiving multimedia content.

FIG. 5 is a block diagram illustrating a general example of a computer that is used in accordance with the subject matter.

### DETAILED DESCRIPTION

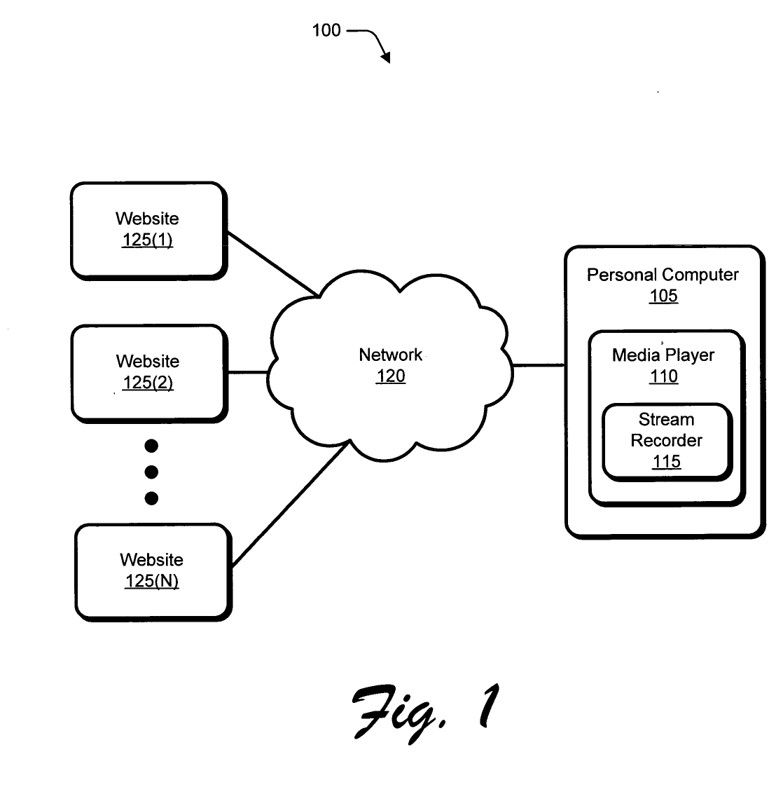

FIG. 1 shows a system 100 that provides multimedia content to a personal computer configured to play and record the multimedia content.

A personal computer (PC) 105 includes an application media player 110 that may be implemented in software. Media player 110 is configured to interact with input output devices, processing devices, and other software/hardware devices of PC 105, and is used to render (i.e., play) multimedia content that is received. PC 105 may be considered a playback computer that is capable of rendering multimedia content.

Media player 110 includes various software components, and specifically includes a stream recorder component 115. Stream recorder component 115 allows non-copyrighted multimedia content that is received and rendered by media player 110 to be recorded. Stream recorder component 115 may be added as a “plug-in” component to media player 110 as further discussed below. As a plug-in component to media player 110, stream recorder 115 and its subcomponents are able to query media player 110 as to states regarding the playing of multimedia content.

PC 105 is connected to a network 120 which potentially includes the public Internet. Network 120 is further connected to multiple websites 125(1), 125(2) . . . 125(N). Websites 125 include Internet radio stations, news services, and promotional commercial sites. Multimedia content is streamed from websites 125 through network 120 to PC 105. The multimedia content includes audio and video content. Multimedia content which is non-copyrighted or non-protected may be recorded. If authorized to record, PC 105 may record copyrighted or protected multimedia content. However without authorization, multimedia content that is identified as copyrighted (i.e. protected) may not be recorded. Copyrighted multimedia content may employ digital rights management (DRM) techniques for protection, where DRM techniques make use of encryption keys to encrypt and decrypt protected content. Authorization allowing PC 105 to record may be through a DRM protocol that acknowledges that PC 105 has the proper decryption keys to decrypt protected multimedia content. The DRM protocol may be predetermined between the PC 105 and the source (i.e., the website) prior to the multimedia content being received.

DRM techniques allow a user of a PC authorized to record copyrighted multimedia content to play back the multimedia content and prevent other computers or other users of the PC from playing back the recorded multimedia content, since only the authorized user on the PC has the proper decryption keys.

Media Player

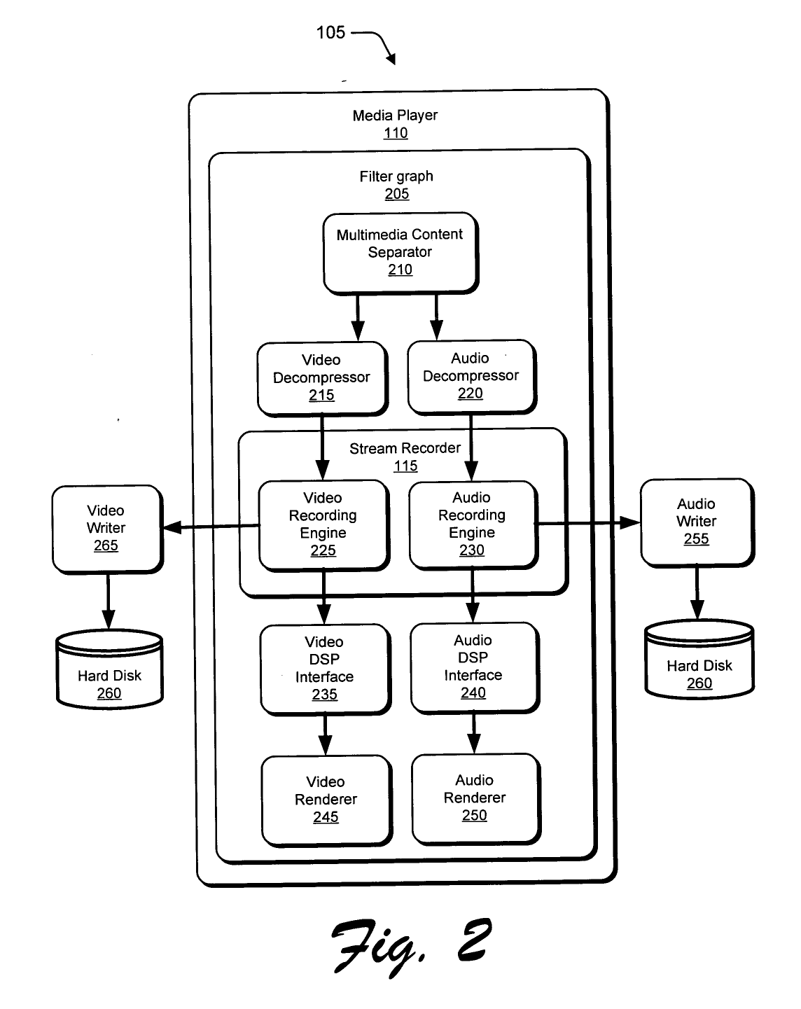

FIG. 2 shows PC 105 which includes media player application 110 that is configured to render and record multimedia content.

Media player 110 may use a filter graph 205 in order to render multimedia content. Media player 110 creates filter graph 205 whenever new multimedia content is received by media player 110. Filter graph 205 is destroyed once media player 110 stops receiving multimedia content. This allows only a single instance of multimedia to be played by the media player 110.

Filter graph 205 is comprised of multiple filters or components that are linked with one another in order to process multimedia content. Such filters or components may be implemented as software components. In certain cases, the filters or components may simply pass on multimedia content without performing any processing. Certain filters or components are needed to render multimedia content, while other filters or components are optional.

It is contemplated that filter graph 205 is created and the multiple filters or components that were previously installed in the computer are added to the filter graph 205 when rendering either video or audio content. This may be referred to as installation. As further discussed below, installation may include all or selected filters or components.

A multimedia content separator 210 receives and separates (i.e., parses) audio and video content streams from a source such as websites 125 of FIG. 1. Multimedia content is typically compressed when transmitted from a source. Compressed video content is received by a video decompressor component 215 and decompressed. Compressed audio content is received by audio decompressor component 220 and decompressed.

Decompressed video and audio content are passed on to stream recorder 115 which includes a video recording engine 225 and an audio recording engine 230. Filter graph 205 provides for the ability to add and delete particular software component (i.e., filter), and stream recorder 115 is such a software component. In other words stream recorder 115 is an optional filter or component that may be included in filter graph 205. If multimedia content is identified as protected by DRM (i.e., the PC 105 is not authorized to record the multimedia content), stream recorder 115 is not loaded or added to filter graph 205. Otherwise, if PC 105 is authorized (i.e., has the proper DRM decryption keys to) to record the protected multimedia content, stream recorder 115 is added to the filter graph 205. In certain cases, video recording engine 225 and audio recording engine 230 are treated as separate filters or components, and as such may be added or omitted in filter graph 205.

Decompressed video content is received by video recording engine 225 and decompressed audio content is received by audio recording engine 230. In certain cases, as discussed below, video recording engine 225 records received video content and audio recording engine 230 records received audio content. Video and audio content may be time stamped at video recording engine 225 and audio recording engine 230 in order to synchronize video and audio.

Regardless of whether recording is performed at video recording engine 225 and/or audio recording engine 230, video content is passed on to a video digital signal processor (DSP) interface 235 and audio content is passed on to an audio DSP interface 240. Video recording engine 225 and audio recording engine 230 may be considered as digital signal processors and are provided with respective DSP interfaces 235 and 240.

Video DSP interface 235 sends video content to a video renderer 245 that processes the video content for use by a video output device such as a display (not shown) of PC 105. Audio DSP interface 240 sends audio content to an audio renderer 250 that processes the audio content for use by audio output device such as an audio driver card (not shown) of PC 105.

When audio recording engine 230 is instructed to record audio content, audio content received by audio recording engine 230 is sent to an audio writer component 255. Audio writer component 255 records the audio content to a local storage device such as hard disk 260. Audio writer component 255 may compress audio content in order to save storage space. Audio content may be recorded in particular format such as Windows® Media Audio (WMA) format. Similarly, when video recording engine 225 is instructed to record video content, video content received by video recording engine 225 is sent to a video writer component 265. Video content may be compressed by video writer component 265 and saved in a particular format such as Windows® Media Video (WMV) format. Video writer component 265 records video content to hard disk 260. In certain cases, audio recording engine 230 and video recording engine 225 may send content to the same writer component where the writer component multiplexes the audio and video content into a format such as audio video interleave (AVI) and saves the multiplexed content as a single file in hard disk 260.

Stream Recorder

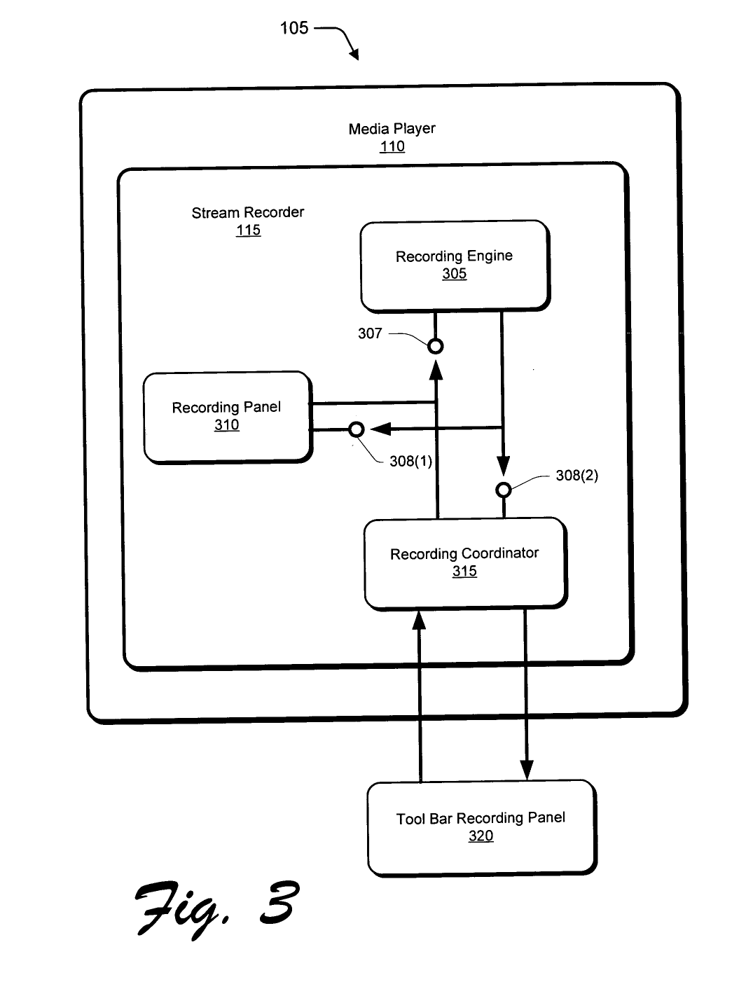

FIG. 3 shows operation of stream recorder 115 in PC 105. Stream recorder 115 includes a recording engine 305 which includes video recording engine 225 and audio recording engine 230.

Recording engine 305 may be implemented as a plug-in software component, and in particular defined as a component object model (COM) object. COM objects are defined by the Microsoft(g) Corporation, and are identified by particular globally-unique identifiers (GUID). COM objects further provide specific interfaces to access or communicate with other COM objects. Interfaces provide a handshake protocol for format negotiation. For example, format negotiation defines an input format which recording engine 305 receives and an output format which recording engine 305 sends.

In this case, recording engine 305 has an interface 307 which may be referred to as a “RecordingEngine” interface that may be called by other objects such as user interface (UI) components which control recording behavior of recording engine 305. “RecordingEngine” interface 307 supports operations such as “Start Recording”, “Pause Recording” and “Stop Recording”. Furthermore. recording engine 305 uses an interface 308(1) and 308(2) that may be referred to as “RecordingEngineEvents” interface that is used to notify other objects or UI components of changes in recording states of recording engine 305.

During its installation, the recording engine 305 registers itself with an operating system of PC 105 as either an audio recording engine plug-in (e.g., audio recording engine 230) or a video recording engine plug-in (e.g., video recording engine 225), and registers itself as a plug-in that may be used by media player 110.

When registered and enabled, the recording engine 305 is loaded when filter graph 205 is created to render audio (i.e., audio recording engine 230 is loaded if the audio content is non-protected or is protected-with-recording-permission) and/or video (i.e., video recording engine 225 is loaded if the video is non-protected or protected-with-recording-permission).

A user may initiate data flow through recording engine 305 by indicating any multimedia content to be played at media player 110. Media player 110 constructs (installs and links) the appropriate filters to create filter graph 205 to process the media content as described in FIG. 2. If recording engine 305 is enabled, multimedia player 110 detects whether recording engine 305 is able to process the format of the multimedia content through format negotiation. If format negotiation succeeds, the recording engine 305 is included in the filter graph 205 of FIG. 2, allowing for recording of multimedia content. Media player 110 runs filter graph 205 which allows the multimedia content to be rendered (i.e., played).

A flag may be set in recording engine 305 to indicate whether content is to be recorded. If the flag is set to true, a writer component such as audio writer 255 and video writer 265 has either been initialized, or is created and initialized.

The recording engine 305 may be implemented as a singleton COM object which provides a maximum of one instance of the recording engine 305 for audio or video (i.e., an audio and video recording engine may concurrently be present, but only one audio and one video recording engine may be present at a time).

Since the recording engine 305 is a singleton COM object, when different UI components reference a recording engine object, they are referenced to the particular instance of recording engine 305.

Stream recorder 115 includes recording panel 310. Recording panel 310 provides a UI that allows a user to start, pause and stop recording, and may further advise the user of current status of recording (e.g., currently recording, currently paused, currently stopped). The recording panel 310 may be implemented as a plug-in COM object that communicates with recording engine 305 through COM defined interfaces, and in this example “RecordingEngine” interface 307 and “RecordingEngineEvents” interface 308(1). Recording panel 310 provides for a user to control settings that affect recording engine 305. Recording panel 310 is created when the user invokes a UI for a particular setting or settings supported by recording panel 310. Recording panel 310 is destroyed when the user closes the particular UI area or chooses to view a different settings UI (i.e., UI for a different functionality, such as a graphic equalizer).

When the recording panel 310 is created, it creates or looks for an instance of recording engine 305 and receives a pointer to “RecordingEngine” interface 307. The recording panel 310 checks whether the recording engine 305 is correctly installed and thereby enabled by media player 110, and if not an error message is displayed. If the recording engine 305 is correctly installed and enabled, recording panel 310 can subscribe to the events of recording engine 305 via “RecordingEngineEvents” interface 308(1) and as a result it is notified of any change of events from recording engine 305. A query through “RecordingEngine” interface 307 may also be performed to recording engine 305 to determine the current recording status. The recording engine 305 is aware of the current recording status. Likewise recording panel 310 may receive from media player 110 the current playback status and subscribe to receive from media player 110 notifications such as playback status changes. The recording panel 310 may update its UI depending upon the current recording and playback status that is received. For example, if the media player is stopped and is not playing any media content, the UI to “start recording” is disabled.

Commands initiated at the recording panel 310 results in appropriate changes to other controls on recording panel 310. For example, if the “start recording” command is initiated at recording panel 310, the recording panel 310 sets a name of a to-be-encoded multimedia file, retrieves metadata of the current multimedia content from media player 110 and initiates the recording engine 305 to start recording.

When a recording event occurs (e.g., recording is completed), a corresponding event handler of the recording panel 310 is called by the recording engine 305 through the “RecordingEngineEvents” interface 308(1). Upon receiving a recording event, the recording panel 310 updates its UI. For example, when recording has completed, the “stop recording” UI may be disabled and the “start recording” UI may be enabled.

Stream recorder 115 includes a recording coordinator 315 that is implemented as a background UI plug-in of media player 110. Furthermore, recording coordinator 315 may be implemented as a COM object that interfaces with recording engine 305.

An instance of recording coordinator 315 may be created when media player 110 is started. The particular instance is deleted when media player 110 stops playing content. The recording coordinator 315 provides the ability for applications external to media player 110 to control recording behavior of recording engine 305. In this example, an application tool-bar recording panel 320 is shown which may be part of PC 105's operating system.

The recording coordinator 315 may have a hidden window associated with it which is created at startup of media player and is destroyed when the media player 110 is shut down. The hidden window provides a messaging mechanism for the recording coordinator 315 and an external application such as tool-bar recording panel 320 to communicate recording information back and forth.

Recording panel 315 is able to receive playback change notifications from media player 110 and sends the notifications to an external application such as tool-bar recording panel 320. Further, recording state change notifications received from recording engine 305 through “RecordingEngineEvents” interface 308(1) may be received and sent to external applications such as tool-bar recording panel 320.

When recording coordinator 315 is created, it creates or looks for an instance of recording engine 305 and receives a pointer to “RecordingEngine” interface 307. Through “RecordingEngineEvents” interface 308(2), recording coordinator 315 subscribes to the recording events of recording engine 305 and further subscribes to playback state notifications from media player 110. Recording coordinator 315 checks whether an external application such as tool-bar recording panel 320 exists. If the external application is recognized, recording coordinator 315 sends a message to the external application that indicates playback and current recording states.

The recording coordinator 315 may also listen to predefined messages from external applications (e.g., tool-bar recording panel 320) indicating recording start/stop/pause behavior. When a specific message containing a recording command from an external application, in this example tool-bar recording panel 320, is received, the recording coordinator 315 passes that command to the recording engine 305 via the “RecordingEngine” interface 307.

When a recording event occurs, such as when recording is completed, or recording is paused, or recording is stopped, the recording coordinator 315 sends a corresponding message to the tool-bar recording panel 320 so that tool-bar recording panel 320 may update its UI state.

Likewise, when playback state changes in media player 110 the recording coordinator 315 receives the corresponding notification from media player 110. Recording coordinator 315 sends the notification to tool-bar recording panel 320 so that tool-bar recording panel 320 may update its UI state.

The tool-bar recording panel 320 provides an accessible UI component through which a user can control recording functionality. A user may not have media player 110 as a foreground application at all times when media is being played. For example, the media player 110 application window may be minimized or put in the background. Tool-bar recording panel 320 may be optionally turned on by a user. Particular scenarios include placing a window on a taskbar next to a system clock, providing start, pause, stop recording controls to access recording functionality. Similar to the recording panel 310, the tool-bar recording panel 320 provides a UI to start, pause and stop recording. The difference is that the recording panel 320 is a component of media player 110, while the tool-bar recording panel 320 is an external application. In the specific example where the tool-bar recording panel 320 appears as a window on the taskbar next to the system clock, it is a desk band object (i.e., a plug-in component to the operating system shell).

The two UI components to recording engine 305 allow users to control recording either through media player 110 through recording panel 310 or through an operating system desktop through tool-bar recording panel 320.

Exemplary Recording Session

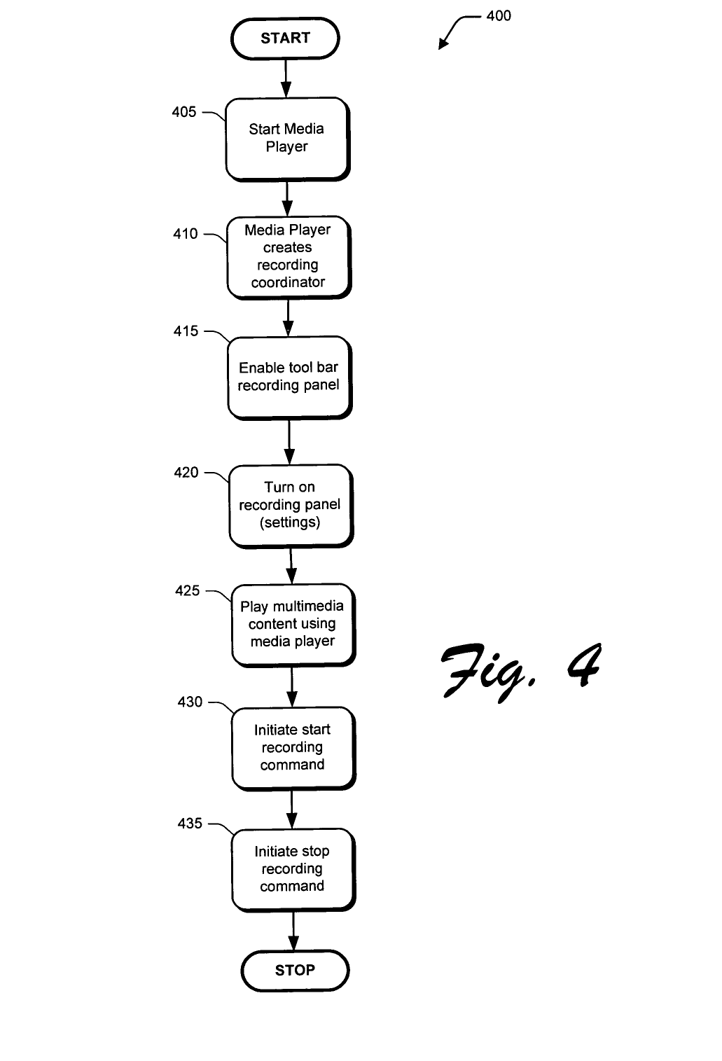

FIG. 4 shows a process 400 describing control flow in an example recording session.

At block 405, the media player 110 is started. A user may initiate media player 110 to start rendering or playing multimedia content.

At block 410, upon media player 110 starting up, media player 110 creates the recording coordinator 315. When recording coordinator 315 is created, it creates an instance of the recording engine 305. Recording coordinator 315 subscribes to recording events of the recording engine 305 through the “RecordingEngineEvents” interface 308(1) and obtains current playback state from media player 110 and the current recording state from the recording engine 305 using the “RecordingEngine” interface 307. Recording coordinator 315 looks for an external application such as tool-bar recording panel 320. If the tool-bar recording panel 320 is found, recording coordinator 315 sends a current recording and playback status message to tool-bar recording panel 320.

At block 415, the tool-bar recording panel 320 is enabled. Tool-bar recording panel 320 may be enabled by a user through a desktop interface such as a taskbar menu option. When tool-bar recording panel 320 is created it checks whether media player 110 is active and running. If media player 110 is active and running, tool-bar recording panel 320 detects if recording coordinator 315 exists as part of media player 110 (i.e., a child window within an application window of media player 110). If the recording coordinator 315 is found, the tool-bar recording panel 320 sends a message that it was enabled by a user to the recording coordinator 315. The message may be sent by passing a unique window handle associated with the tool-bar recording panel 320. The recording coordinator 315 in turn sends the tool-bar recording panel 315 a message indicating current recording and playback status. The tool-bar recording panel 315 updates its UI per the current recording and playback status. All the recording controls are disabled at this stage.

At block 420, the recording panel 310 may be activated by a user through the media player 110. In particular the media player 110 creates an instance of the recording panel 310. When started, the recording panel 310 creates an instance of the recording engine 305; however if recording engine 305 has been created at step 410, only a single instance of recording engine 305 may be present. Through the “RecordingEngine” interface 307 recording panel 310 references the existing instance of recording engine 305 allowing queries to be performed as to the current state of the recording engine 305. Through “RecordingEngineEvents” interface 308(2) recording panel 310 subscribes to events of recording engine 305. Recording panel 310 also receives playback state change notifications of the media player 110 which allows queries as to current playback state of the media player 110.

At block 425, media player 110 is instructed to play multimedia content, such as multimedia content received from an Internet radio station. Media player 110 builds an instance of a filter graph such as filter graph 205.

During installation, the recording engine 305 registers itself to an addressable location in a hard drive of PC 105 (for example, in the system registry) as either an audio recording engine plug-in (e.g., audio recording engine 230) or a video recording engine plug-in (e.g., video recording engine 225). When rendering of audio or video content is performed, media player 110 detects the recording engine 305 as a registered plug-in (filter) for the filter graph. Media player 110 may try to create an instance of the recording engine 305; however since an instance has been created, media player 110 references the existing instance of recording engine 305 and adds it to the filter graph. Format negotiation is performed by media player 110 with recording engine 305 as to the format of uncompressed content that is input to the recording engine 305 and the format of uncompressed content to be output from the recording engine 305. Content is played using the created filter graph. The media player 110 may send event notifications to subscriber components indicating the change of state from “not playing” to “playing”. Recording panel 310 receives the event notification and updates its recording UI to enable recording. The recording coordinator 315 receives the event notification and sends a corresponding message to tool-bar recording panel 320 to update its UI to enable recording.

At block 430, a user may initiate recording through the recording panel 310. (The user may initiate recording either through the recording panel 310 or through tool-bar recording panel 320; however in this example, the recording is initiated through recording panel 310). The recording panel 310 initializes the recording engine 305 through “RecordingEngine” interface 307 with a name of the file to record the content to. As an optional, the name of the file to record the content to may be auto-generated using some user options such as the folder to save the recorded file into and the date and time of recording. Recording panel 310 may query the media player 110 as to information which may be part of metadata about the content that is being played. Information may include title, author, and type of content. Recording panel 310 provides this information to the recording engine 305 to save along with the recorded content. Recording panel 310 initiates recording engine 305 through the “RecordingEngine” interface 307. The recording engine 305 changes its internal flag to “record” to indicate recording. The next time uncompressed content passes through the created filter graph, the recording engine 305 initializes recording by creating an instance of a writer component such as audio writer 255 and video writer 265. The recording engine 305 further sets up the appropriate input format for uncompressed content received at the writer component, and output format for the compressed file that is output by the writer component, and the output filename of the file recorded to a storage device such as hard disk 260 of FIG. 2.

The recording engine 305 sends notification events to subscribers through the “RecordingEngineEvents” interface 308(1) and 308(2) indicating start of recording. The “recording panel” 310 receives the event notification and updates its UI to indicate recording, disabling “Start Recording”, and enabling “Pause Recording” and “Stop Recording”. Similarly the recording coordinator 315 receives the event notification and sends the event notification to the tool-bar recording panel 320. The tool-bar recording panel 320 updates its UI by disabling “Start Recording” and enabling “Stop Recording” and “Pause Recording”. As long as the internal flag of recording engine 305 is set to record, content samples received by recording engine 305 are passed to the writer component to be recorded before being passed along the filter graph for rendering.

At block 435, a user may stop recording by initiating a “stop recording” command”. This action may be performed from the tool-bar recording panel 320 or through the recording panel 310. This example assumes that the action is performed through the tool-bar recording panel 320. The tool-bar recording panel 320 receives the “stop recording” command from user and sends a message to recording coordinator 315 to stop recording. The recording coordinator 315 indicates to recording engine 305 through “RecordingEngine” interface 307 to stop recording. When recording engine 305 receives the indication from recording coordinator 315, the recording engine 305 changes its internal flag to indicate that no further recording is to take place and that content no longer is passed to the writer component for recording.

The recording engine 305 finalizes recording of the recorded file processed by the writer component. Recording engine 305 may add the metadata that was queried by the media player 110 in block 430 to the recorded file. Recording engine 305 closes the file to be recorded, and deletes the writer component.

The recording engine 305 sends an event notification to subscribers through the “RecordingEngineEvents” interface 308(1) and 308(2) indicating end of recording. The “recording panel” 310 receives the event notification and updates its UI to indicate end of recording by enabling “Start Recording” and disabling “Stop Recording” and “Pause Recording”. Similarly the recording coordinator 315 receives the event notification and passes it on to the tool-bar recording panel 320. The recording engine 305 may add the recorded file to a folder or library in PC 105.

Exemplary Computer Environment

The subject matter is described in the general context of computer-executable instructions, such as program components, being executed by a computer such personal computer 105 of FIG. 1. Generally, program components include routines, programs, objects, components, data structures, etc. that perform particular tasks or implement particular abstract data types. Moreover, those skilled in the art will appreciate that the subject matter may be practiced with other computer system configurations, including hand-held devices, multiprocessor systems, microprocessor-based or programmable consumer electronics, network PCs, minicomputers, mainframe computers, and the like. In a distributed computer environment, program components may be located in both local and remote memory storage devices.

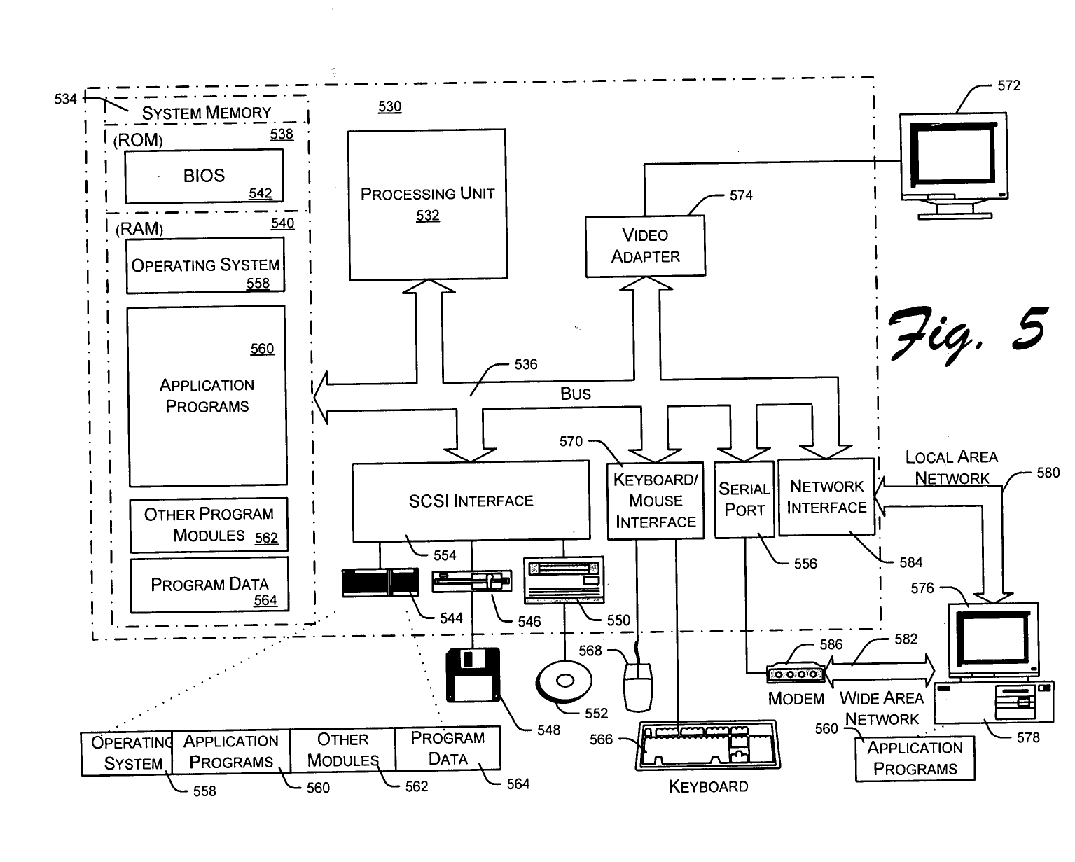

FIG. 5 shows a general example of a computer 530 that is used in accordance with the subject matter. Computer 530 is shown as an example of a computer that can perform the functions of a server computer or a remote client computer. Computer 530 includes one or more processors or processing units 532, a system memory 534, and a bus 536 that couples various system components including the system memory 534 to processors 532. Processors 532 may initiate or configured to initiate a session with another computer.

The bus 536 represents one or more of any of several types of bus structures, including a memory bus or memory controller, a peripheral bus, an accelerated graphics port, and a processor or local bus using any of a variety of bus architectures. The system memory includes read only memory (ROM) 538 and random access memory (RAM) 540.

A basic input/output system (BIOS) 542, containing the basic routines that help to transfer information between elements within computer 530, such as during start-up, is stored in ROM 538. Computer 530 further includes a hard disk drive 544 for reading from and writing to a hard disk, not shown, a magnetic disk drive 546 for reading from and writing to a removable magnetic disk 548, and an optical disk drive 550 for reading from or writing to a removable optical disk 552 such as a CD ROM or other optical media. The hard disk drive 544, magnetic disk drive 546, and optical disk drive 550 are connected to the bus 536 by an SCSI interface 554 or some other appropriate interface. The drives and their associated computer-readable media provide nonvolatile storage of computer readable instructions, data structures, program components and other data for computer 530.

Although the exemplary environment described herein employs a hard disk, a removable magnetic disk 548 and a removable optical disk 552, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the exemplary operating environment.

A number of program components may be stored on the hard disk, magnetic disk 548, optical disk 552, ROM 538, or RAM 540, including an operating system 558, one or more application programs 560, other program components 562, and program data 564.

A user may enter commands and information into computer 530 through input devices such as keyboard 566 and pointing device 568. Other input devices (not shown) may include a microphone, joystick, game pad, satellite dish, scanner, or the like. These and other input devices are connected to the processing unit 532 through interface 570 that is coupled to bus 536. Monitor 572 or other type of display device is also connected to bus 536 via an interface, such as video adapter 574.

Computer 530 operates in a networked environment using logical connections to one or more remote computers, such as a remote computer 576. The remote computer 576 may be another personal computer, a server, a router, a network PC, a peer device or other common network node, and typically includes many or all of the elements described above relative to computer 530, although only a memory storage device 578 has been illustrated in FIG. 5. The logical connections depicted in FIG. 5 include a local area network (LAN) 580 and a wide area network (WAN) 582. Such networking environments are commonplace in offices, enterprise-wide computer networks, intranets, and the Internet.

When used in a LAN networking environment, computer 530 is connected to the local network 580 through a network interface or adapter 584. When used in a WAN networking environment, computer 530 typically includes a modem 586 or other means for establishing communications over the wide area network 582, such as the Internet. The modem 586, which may be internal or external, is connected to the bus 536 via a serial port interface 556. In a networked environment, program components depicted relative to the personal computer 530, or portions thereof, may be stored in the remote memory storage device. It will be appreciated that the network connections shown are exemplary and other means of establishing a communications link between the computers may be used.

Generally, the data processors of computer 530 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory.

The subject matter described herein includes these and other various types of computer-readable storage media when such media contain instructions or programs for implementing the steps described below in reference to FIG. 5 in conjunction with a microprocessor or other data processor.

The subject matter also includes the computer itself when programmed according to the methods and techniques described below. Furthermore, certain sub-components of the computer may be programmed to perform the functions and steps described below. The subject matter includes such sub-components when they are programmed as described. In addition, the subject matter described herein includes data structures, described below, as embodied on various types of memory media.

For purposes of illustration, data, programs and other executable program components, such as the operating system are illustrated herein as discrete blocks, although it is recognized that such programs and components reside at various times in different storage components of the computer, and are executed by the data processor(s) of the computer.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
receiving multimedia content from a source;
creating a linked set of components to process the multimedia content;
determining authority to record the multimedia content;
providing a recording component in the linked set of components to record the multimedia content if authorized to record the multimedia content; and
rendering the multimedia content with use of the linked set of components.

2. The method of claim 1 wherein the receiving is from an Internet website.

3. The method of claim 1 wherein the receiving comprises protected multimedia content.

4. The method of claim 1 wherein the receiving comprises encrypted multimedia content and the determining is based as to the ability to decrypt the multimedia content.

5. The method of claim 1 wherein the creating comprises components to render the multimedia content whether providing a recording component is performed or not.

6. The method of claim 1 wherein the creating is performed for every instance multimedia content is received.

7. The method of claim 7 wherein the linked set of components is destroyed once rendering is complete.

8. The method of claim 1 wherein the determining authority is based on a predetermined protocol with the source.

9. The method of claim 8 wherein the predetermined protocol is based on encryption and decryption keys shared with the source.

10. The method of claim 1 wherein the providing the recording component is omitted if not authorized to record the multimedia content.

11. The method of claim 1 wherein the providing a recording component comprises a writer component connected to the recording component which stores the multimedia content to a local storage device.

12. The method of claim 11 wherein the multiplexes audio and video content.

13. The method of claim 11 wherein the writer component compresses the multimedia prior to storing to the local storage device.

14. The method of claim 11 wherein the write component makes use of a predetermined protocol to store the multimedia content to the local storage device, where the predetermined protocol is used to play back the multimedia content.

15. The method of claim 1 wherein the providing is based on the recording component being registered to be installed in the linked set of components.

16. The method of claim 1 further comprising establishing a user interface component to the recording component.

17. The method of claim 16 wherein the user interface component provides status as to recording and rendering states.

18. The method of claim 16 wherein the user interface component is part of a media player that comprises the linked set of components.

19. The method of claim 16 wherein the user interface component is external to a media player that comprises the linked set of components.

20. A personal computer that performs the method of claim 1.

21. A method comprising:
receiving a stream of multimedia content from a source;
separating the streamed multimedia content into audio content and video content;
initiating a first linked set of components to process the audio content, and a second linked set of components to process the video content;
creating a first recording component in the first linked set of components to record the audio content if authorized, and a second recording component in the second linked set of components to record video content if authorized; and
providing audio output from the first linked set of components and video output from the second linked set of components.

22. The method of claim 21 wherein the receiving the stream of multimedia content is from a separate source on a network.

23. The method of claim 21 wherein the receiving the stream of multimedia content is from an Internet source.

24. The method of claim 21 wherein the receiving the stream comprises protected multimedia content.

25. The method of claim 21 wherein the creating is performed based on registration of the first recording component as authorized to record audio content, and registration of the second recording component as authorized to record video content.

26. The method of claim 25 wherein the creating of first and second recording components is based on a predetermined protocol to allow recording of audio and video content.

27. The method of claim 25 wherein the creating of the first recording component as authorized to record if audio content is not protected, and creating the second recording component as authorized if video content is not protected.

28. The method of claim 25 wherein the creation of the first recording component as authorized to record if a predetermined protocol is established to allow audio content to be copied, and creation of the second recording component as authorized if the predetermined protocol is established to allow video content to be copied.

29. A computer comprising:
means for receiving streaming multimedia content;
means for rendering the streaming multimedia content;
means for storing the streaming multimedia content if so authorized; and
means for playing back the stored multimedia content.

30. The computer of claim 29 wherein the multimedia content comprises audio content and video content.

31. The computer of claim 29 wherein the means for receiving is from an Internet website.

32. The computer of claim 29 wherein the means for rendering comprises creating a linked set of components.

33. The computer of claim 32 wherein the linked set of components comprises a recording component.

34. The computer of claim 32 wherein the linked set of components is created for every instance multimedia content is received.

35. The computer of claim 29 wherein the means for storing comprises a writer component that is initiated if multimedia content is authorized to be stored.

36. The computer of claim 29 wherein the means for storing comprises setting a flag in a recording component to indicate that multimedia content is authorized to be stored.

37. A computer comprising:
a memory;
a processor coupled to the memory; and
instructions stored in the memory and executable on the processor to access streaming multimedia content from a source, render the streaming multimedia content, initiate a recording component to record the multimedia content if the computer is so authorized, and store multimedia content to a local storage device.

38. The computer of claim 37 wherein the streaming multimedia content is received from an Internet website.

39. The computer of claim 37 wherein the streaming multimedia comprises encrypted multimedia content.

40. The computer of claim 39 wherein the computer is so authorized to record the multimedia content if the computer is able to decrypt the encrypted multimedia content.

41. The computer of claim 37 wherein the instructions further comprise separating the multimedia content into audio content and video content that are rendered separately.

42. The computer of claim 37 wherein the instructions further comprise providing a user interface to initiate rendering and recording.

43. The computer of claim 42 wherein the user interface provides status as to playing and recording states.

44. A computer-readable medium having computer-executable instructions for performing steps comprising:
contacting a server computer to send multimedia content;
receiving the multimedia content;
separating the multimedia content into audio content and video content;
decompressing the audio content and video content;
creating an instance of a recording component to record the decompressed audio content and video content if so authorized to record;
rendering to audio output the decompressed audio content and to video output the decompressed video content; and
destroying the instance of the recording component after the multimedia content is rendered.

45. The computer-readable medium of claim 44 further comprising a step of writing the decompressed audio and video content to a local file if so authorized to record.

46. The computer-readable medium of claim 44 further comprising a step of providing states as to recording and rendering.

47. A system comprising:
a server computer; and
a playback computer configured to receive multimedia content from the server computer, render the multimedia content, and write the multimedia content to a storage device if so authorized.

48. The system of claim 47 wherein the server computer is a website server computer connected to the playback computer by the Internet.

49. The system of claim 47 wherein the multimedia content comprises audio content and video content.

50. The system of claim 47 wherein the multimedia content is streamed from the server computer to the playback computer.

51. The system of claim 47 wherein the multimedia content includes protected multimedia content.

52. The system of claim 51 wherein the server computer and the playback computer exchange keys in order for the playback computer to render the multimedia content.

53. The system of claim 47 wherein the server computer authorizes the playback computer to record the multimedia content by a predetermined protocol.

54. The system of claim of claim 53 wherein the predetermined protocol comprises exchange of decryption and encryption keys for protected multimedia content.
